(19) United States
(12) Patent Application Publication
(10) Pub. No.: US 2005/0075096 A1
(43) Pub. Date: Apr. 7, 2005

(54) GSM phone applet and method for controlling prayer timings

(76) Inventor: Nassir Abdulrahman Aljuraid, Riyadh (SA)

Correspondence Address: GRAFFITI PROMOTIONS, LLC, 827 WINDSOR ROAD, ARNOLD, MD, 21012, US

(21) Appl. No.: 10/678,660

(22) Filed: Oct. 3, 2003

(51) Int. Cl. H04Q 7/20

(52) U.S. Cl. 455/414.1; 455/420; 455/456.3

(57) ABSTRACT

Mobile phone applets with are downloadable on a J2ME and Symbian platform. The core function of the applet is to utilize a mobile device's calendar with respect to the date and time to control when the phone can and can not ring. Based on the selected applet date and timings are automatically or manually entered into the phone which enable switching the phone's silent mode on and off at a predetermined date and time for a selected duration of time. Additionally the user can use the applet to toggle between profiles on a mobile device.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD OF INVENTION

The present invention relates generally to mobile telephone technology which can be used in particular communication systems for monitoring the sound mode of a mobile phone to correspond to location and religious prayer times.

### BACKGROUND OF THE INVENTION

Communications systems for, for example, BlackBerry™, are generally known. There are, for example, already personal data assistance and mobile phones with a whole series of technically interesting possibilities. A disadvantage of phone products is, however, that they do not allow the user to control features and operations of the phone base on a specified date, time or duration of a particular event that could be scheduled on a calendar.

The object of the invention is to develop a mobile telephone applets with are downloadable on a J2ME and Symbian platform. The core function of the applet is to utilize the mobile phone's calendar with respect to the date and time to control when the device can and can not ring. Based on the selected applet date and timings are automatically or manually entered into the phone which enable switching the phone's silent mode on and off at a predetermined date and time for a selected duration of time. Additionally a user can utilize the applet to toggle between multiple profile settings in the device.

U.S. Pat. No. 6,519,241 issued to Theimer on Feb. 11, 2003 teaches an invention is characterized by the fact that the mobile telephone contains at least one web server. A web server is in this case a software packet that makes available specific information via an interface to the Internet, which information can be interrogated on request by other devices connected to the Internet. By virtue of the fact that the web server is contained in the mobile telephone, a locally independent web server is easily formed, said server being situated with the user of the mobile telephone at all times if the user carries the telephone with him.

In addition, '241 discloses that it is possible for a plurality of servers also to be contained in the mobile telephone or for a plurality of external servers to be connected to the mobile telephone via an air interface. If a plurality of servers are present, they may be, for example, continuously coupled to one another or may be coupled to one another when required. Using an external server, it is possible, for example, for specific information to be transmitted from a service provider via an air interface to the WEB server contained in the mobile telephone. This is advantageous if the information is so extensive that it is not possible to store this information on the locally independent WEB server for reasons of space.

### SUMMARY

The present invention addresses the shortcoming in the prior art with respect to mobile phone technology that does not enable a user to access the calendar software on a mobile phone for the purpose of switching the phone from silent mode to normal mode at a predetermined date and time for a selected length of time. The objective is to ensure that the mobile phone does not ring and disturb the user of others during specific timings.

Two applets created in several embodiments, for instance the applet can be downloaded with selected information with respect to prayer times for a particular city or country where the user is located. In the preferred embodiment the applet will link from the Internet or other web based system with the mobile phone to activate the mobile phone's silent mode during prayer times based on the phones location and owner's desired settings.

In another embodiment, the user can manually set various dates and times using the applet's user interface to program the phone to switch to silent mode and back to normal mode for any other occasion for example: during office hours, important scheduled meetings, party, educational sessions, bedtime and dinner timings.

### BRIEF DESCRIPTION OF THE DRAWINGS

FIG. 1 illustrates the process of applet installation and modes of use

FIG. 2 illustrates Server Mobile Communication

FIG. 3 illustrates the Manual Application

FIG. 4 illustrates the Automatic Application

FIG. 5 illustrates the Application Architecture

FIG. 6 illustrates the Application Flow

FIG. 7 illustrates the Step-by-Step Use Case of the Preferred Embodiment

### DETAILED DESCRIPTION OF THE INVENTION

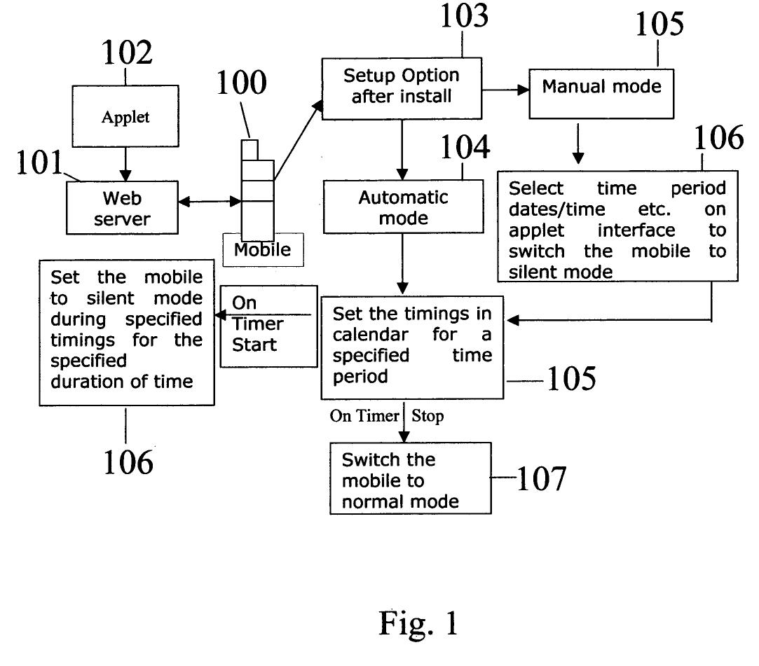

FIG. 1 illustrates the application process of downloading and using an applet to control phone options and functions utilizing the calendar system. The application start with a user's mobile phone (100) requesting an Internet web server (101) to download the applet (102). The actual download process can be accomplished over WAP, HTTP, IR, Bluetooth, or other protocols. In another embodiment the phone could be sold with the applet pre-installed.

Again referring to FIG. 1, once the applet (102) is installed correctly in the user's mobile phone (100) it can perform a series of tasks by selecting a setup option (103) offering an automatic mode (104) or a manual mode (105). In automatic mode (104) the applet uses the predetermined timings to set the timings in the calendar (105), while the manual mode requires the user to select time period dates (106) on the applet interface to control phone settings. Once the calendar timings are set (105) the desired phone function is either on or off. In the preferred embodiment the applet controls the silent and normal sound modes of a mobile phone. The calendar settings (105) either start the silent mode (106) for a specified duration of time or start the normal mode (107) for a specified duration of time and continually repeats the process depending on the timing setting (105) that are place in the mobile phone's calendar system.

In the preferred embodiment, the basic objective of the present invention is to switch the mobile phone to silent mode during the prayer time or predefined time and set the phone to normal mode after the time is over. The applet may also switch the mobile devices phone profile from one stetting to another to perform the same operation. For example the applet can be used to toggle the mobile device or a mobile phone from profile A to profile B and vice versa.

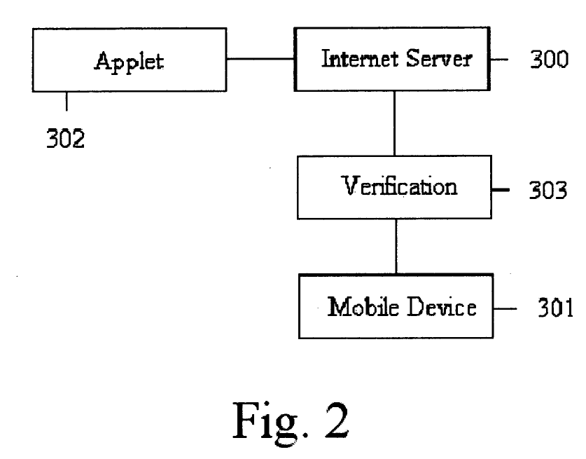

Now referring to FIG. 2, communication between the Internet server (300) and the mobile phone (301) is initiated by the mobile phone (301) which sends a request to the Internet server (300) for a specific applet (302). The Internet server (300) provides the user with an applet (302) via a download after proper verification (303). Once the transmission is complete, the mobile phone (301) and Internet server (300) end the connection. Although one embodiment of the invention is to use the Internet is should be appreciated that other embodiments of the invention will exists. For example it is possible to for a mobile device to receive the applet from another mobile device, PC, or other storage media.

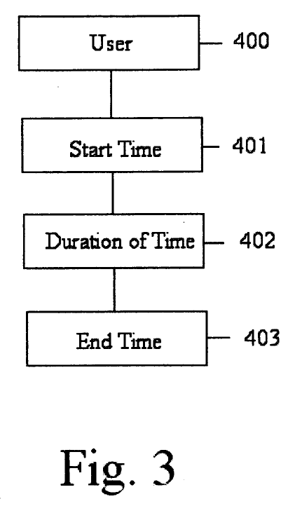

FIG. 3 illustrates the steps necessary to teach the applets manual mode of operation for entering date, time, and duration information. In the manual option, the user (400) with have the option to manually select the time period utilizing a simple interface by designating the start time (401) and end time (402) for a specific period (403).

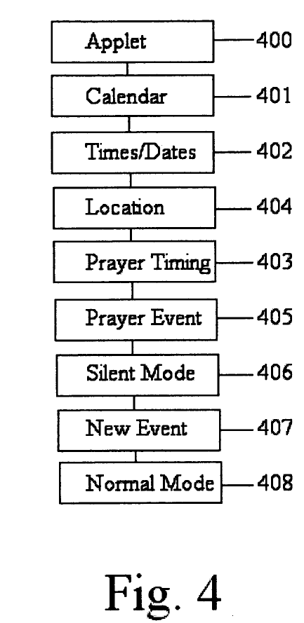

FIG. 4 illustrates the steps for the automated process of downloading the updated the calendar to control functions of a mobile phone. In the automatic option, once the applet (400) is downloaded it will automatically start to set up the calendar (401) for the dates (402) and timings (403) for prayer timings for a particular location (404). The application will set up these details for a complete year or specified period and schedule an event (405) for each prayer timing (403). Each time that prayer event (405) is reached; the application will switch the mobile to the silent mode (406). Once the prayer event (405) has elapsed a new event (407) is fired that switches the phone back to normal mode (408).

In yet another embodiment the user will be able to use both manual and automatic modes to set his own personalized timings on his mobile phone. Additionally the user could toggle the phone between various profiles.

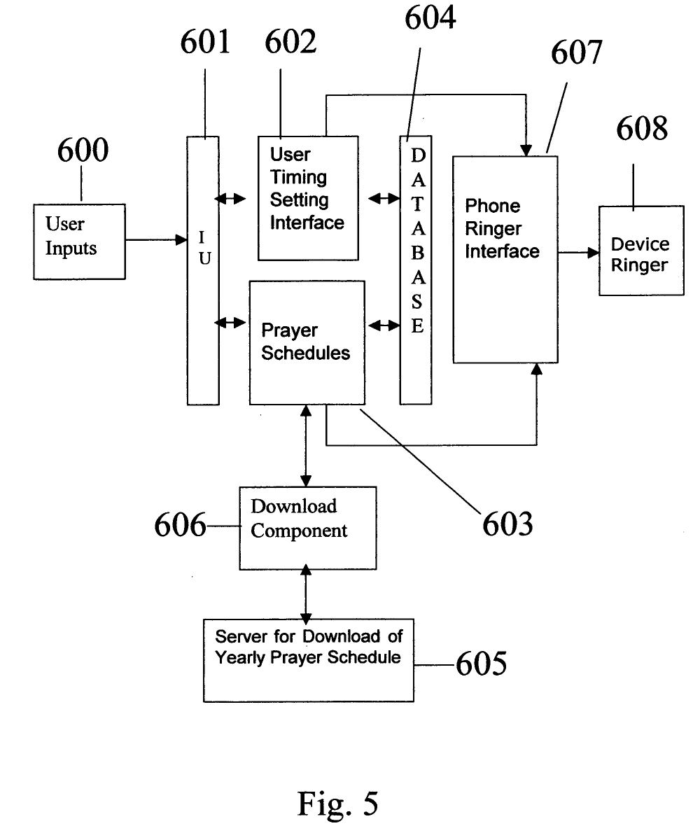

Now referring to FIG. 5 the application architecture is described. Using the simple interface previously discussed, the user inputs selections (600) into the mobile electronic device (601) using the timing setting interface (602) contained in the mobile electronic devices memory (604). Prayer schedules (603) are provided on a remote server (605) and are downloaded as a component (606) to the mobile electronic device (601). The downloaded component (606) and its prayer schedule (603) in conjunction with the timing setting interface (602), both stored in the mobile electronic device's memory (604), send instructions to control the phone ringer interface (607) which then activate and deactivate the device ringer (608) at specified times and for specified time intervals.

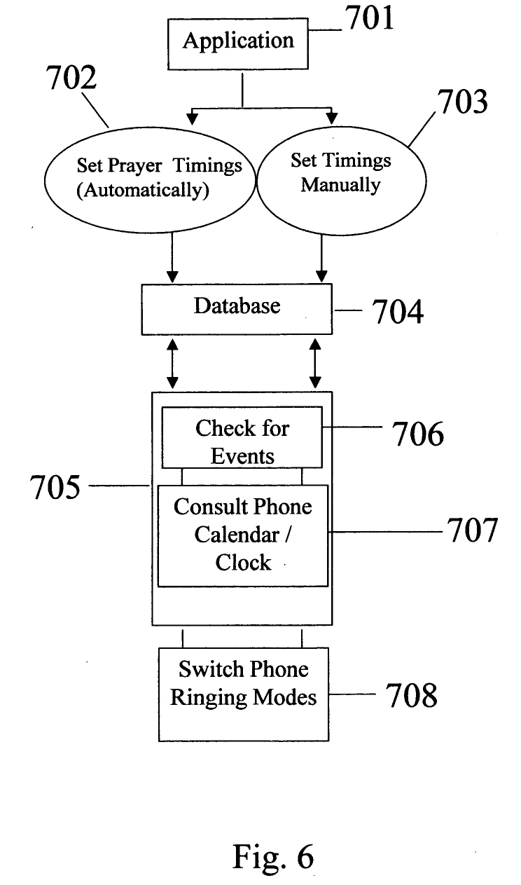

The basic application flow for this method is illustrated in FIG. 6. The application (701) is downloaded to the device and prayer timings can then be set automatically (702) or manually (703) which are then stored in the devices memory database (704). Within the device's electronic system (705) the application checks for events (706) and consults the devices calendar or clock (707) to determine what mode the device's sound system should be in and whether the modes should be switched (708).

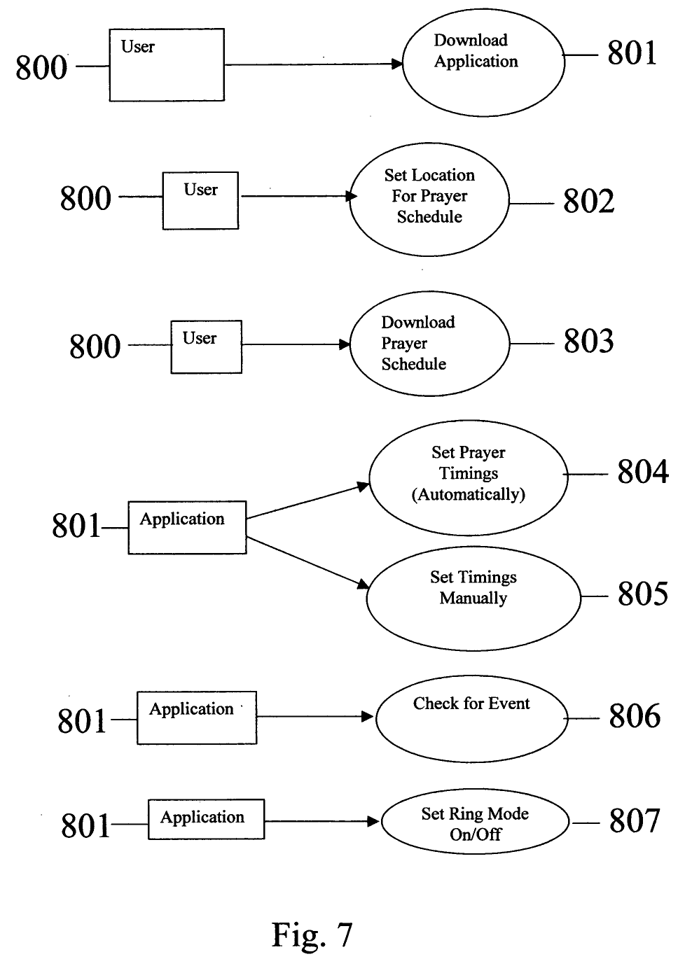

FIG. 7 illustrates the Step-by-Step Use Case of the preferred embodiment of the present invention. A mobile device user (800) will be able to download and install the application (801) on request from a server. The user (800) will then set his location for downloading the prayer schedule based on his location (802) and may download a prayer schedule for a particular location (803). The application (801) will set the prayer setting automatically for the selected location (804) and will also provide for a provision for the user (800) to set the timings for events manually (805). The application (801) will continuously check for events (806) that are generated based on the prayer timings as well as based on manual user input. The application (801) based on the event will set the ring mode (807) to off and reset to on after a particular time has elapsed based on the settings.

Although the description above contains many specificities, these should not be construed as limiting the scope of the invention but as merely providing illustrations of some of the presently preferred embodiments of this invention. Thus, the scope of the invention should be determined by the appended claims and their legal equivalents, rather than by the examples given.

1. A method of configuring an electronic mobile device so as to operate in a predetermined manner, said method comprising:
mobile electronic device with memory comprising a calendar program used for keeping track of dates and times;
mobile electronic device comprising hardware and software enabling connection to the Internet, other web-based system, PC, or other media storage device;
mobile electronic device user accessing a remote system to download and install an application on the mobile electronic device;
user selecting the program and application to switch the mobile electronic device to a silent mode at the start of a specified time and to a normal mode at the end of a specified period of time using said mobile electronic device's calendar program.

2. The method of claim 1, wherein after download of the program the mobile electronic device automatically enters specific timings into the calendar program based on the location of the user or phone.

3. The method of claim 1, wherein after download of the program the mobile electronic device automatically enters specific timings into the calendar program based on the user's religion prayer times.

4. The method of claim 2 or 3, wherein the specific mobile electronic device is a mobile or cellular phone.

5. The method of claim 4, wherein the program controls the ring function of a mobile or cellular phone.

6. The method of claims 1, 2, 3, or 5 wherein the applet allows the selection of multiple user profiles stored on the mobile device.

7. The method of claim 1, wherein after download of the program the mobile electronic device a basic user interface is available which allows the user to manually enter specific timings into the calendar program.

8. A method of configuring an electronic mobile device so as to operate in a predetermined manner, said method comprising:
mobile electronic device with memory comprising a calendar program used for keeping track of dates and times;
mobile electronic device comprising hardware and software enabling connection to the Internet or other web-based system;
mobile electronic device user accessing the Internet, other web-based system, PC, or other media storage device to download and install an application on the mobile electronic device;
user selecting the program and application to switch the mobile electronic device to a silent mode at the start of a specified time and to a normal mode at the end of a specified period of time using said mobile electronic device calendar program;
said program including a prayer schedule component based on the user's religion; said prayer component containing a yearly prayer schedule of dates and times of prayers for a specific geographical location.

9. The method of claim 8 wherein the applet allows the selection of multiple user profiles stored on the mobile device.

10. A method for controlling the ring function of a mobile phone comprising:
a user and mobile phone with the capability to connect to the Internet, other web-based system, PC, or other media storage device with the ability to download and install an application on request from a server;
said user then selecting his location for downloading a prayer schedule based on his location;
said application setting the prayer timings automatically for the selected location; said application also providing for a provision for the user to set the timings for events manually;
the application continuously checking for events that are generated based on the prayer timings as well as based on manual user input;
the application, based on the event, will set the mobile phone's ring mode to off and reset to on after a particular time has elapsed based on the settings.

11. The method of claims 10 wherein the applet allows the selection of multiple user profiles stored on the mobile device.
